(19) United States
(12) Patent Application Publication
(10) Pub. No.: US 2010/0030802 A1
(43) Pub. Date: Feb. 4, 2010

(54) SYSTEM AND METHOD THA ALLOWS RELATIONAL DATA TO BE MODELED EFFICIENTLY AND SYNCHRONIZED WITHOUT CREATING DANGLING REFERENCES

(75) Inventors: Thomas C. Butler, Santa Clara, CA (US); William Leonard Mills, Battle Ground, WA (US)

Correspondence Address: BERRY & ASSOCIATES P.C., 9229 SUNSET BOULEVARD, SUITE 630, LOS ANGELES, CA, 90069, US

(73) Assignee: ACCESS CO., LTD., Tokyo (JP)

(21) Appl. No.: 12/577,116

(22) Filed: Oct. 9, 2009

Related U.S. Application Data
(63) Continuation-in-part of application No. 10/972,965, filed on Oct. 21, 2004.
Application No. 10/972,965 is a continuation-in-part of application No. 11/966,950, filed on Dec. 28, 2007.
Application No. 11/966,950 is a continuation-in-part of application No. 12/186,535, filed on Aug. 6, 2008.

(51) Int. Cl. G06F 7/00; G06F 12/00

(52) U.S. Cl. 707/102; 707/103 R; 707/204; 707/E17.044; 707/E17.055; 711/E12.001

(57) ABSTRACT

Methods and systems to maintain data integrity across a plurality of devices by reducing or preventing dangling references are provided. In one embodiment, all data objects are provided with reference IDs enabling reference to an extant version of an object. In another embodiment, a global synchronization clock per synchronization node is used. Furthermore, in an embodiment, data integrity is enhanced through the use of snapshots during synchronization processes. In another embodiment, forwarding deletes is used to resolve conflicts in a synchronization process. In another embodiment, update ordering is employed to maintain data integrity when adding or deleting data objects.

### CROSS-REFERENCE TO RELATED APPLICATIONS

The present application is a continuation-in-part of co-pending and commonly-assigned U.S. patent application Ser. No. 10/972,965 entitled “Determining Priority Between Data Items in Shared Environments,” U.S. patent application Ser. No. 11/966,950 entitled “Determining Priority Between Data Items,” and U.S. patent application Ser. No. 12/186,535 entitled “Generating Coherent Global Identifiers for Efficient Data Identification,” all of which are incorporated herein by reference. The present application also incorporates by reference the disclosures in U.S. patent application Ser. No. 10/159,077 entitled “Generating Coherent Global Identifiers for Efficient Data Identification” issued as U.S. Pat. No. 6,934,710; U.S. patent application Ser. No. 11/210,023 entitled “Generating Coherent Global Identifiers for Efficient Data Identification” issued as U.S. Pat. No. 7,418,466; and U.S. patent application Ser. No. 10/159,461 entitled “Determining Priority Between Data Items in Shared Environments” issued as U.S. Pat. No. 7,337,193.

### BACKGROUND OF THE INVENTION

1) Field of the Invention

The present invention relates generally to the field of databases. Specifically, the present invention relates to various methods of avoiding dangling references.

2) Background

Individuals commonly use numerous computing devices and information appliances to store and communicate information. For example, a person may use portable computing devices such as a smart cell phone or personal digital assistant (PDA) while in transit, and a laptop or desktop computer system while at work and/or at home. Furthermore, with use of such devices and systems, a user may store data to enable viewing of the data by others via an internet or intranet site on a server system. It is common for a data set to be concurrently maintained on a plurality of these devices. For example, a user may maintain a calendar or address book on both a PDA and a desktop or laptop computer system.

The entries in the data set are typically referred to as “records” or “data objects.” When a change is made to a record in the data set residing on one device (hereafter also referred to as a “node”), it is desirable to have the data set on the other “node” be updated as well, so that the data set is synchronized on both nodes. Accordingly, processes have been developed to facilitate synchronization of the data sets at both nodes. However, as computer systems are networked, multiple communication pathways between PDAs and computer systems can exist, and synchronization between multiple devices can become complicated and needs to be supported.

This added complexity is not just a result of the number of computers users typically carry and use, but also results from the complexity of the programs installed and the number of programs being executed at any given time. This increased complexity gives rise to the fact that competing applications are always fighting for the finite resources of the computer systems. Other than the competition for resources, an ever increasing number of applications and programs require access to the same data in a preferably timely manner.

Another consequence of the mixed type of environment that exists between different types of hardware requiring access to the same data is the actual hardware constraints and performance requirements. For example, a home or office computer running a calendar or address book today may have at a minimum, 1 GB of Ram and a 1.8 ghz dual core processor. On the other hand, a PDA device may have only a 400 mhz processor and 28 MB of Ram. These differences in capabilities facilitate a different way of viewing data management on a PDA from a desktop computer.

A major drawback that arises in database design results from the deletion of elements that are referenced or the renaming of elements that are referenced by other data elements. As an example involving a synchronization scheme with multiple devices, a modification or deletion of one object on a particular device may cause a conflict with a modification to the same or similar object on another device. During a synchronization process, conflicts between the objects must be resolved in a manner so that the intended object is properly propagated. During a synchronization process attempting to resolve different versions of data, objects to be discarded are deleted (so that only the proper copy of a particular object remains). However, other data objects on the same or different device may still reference data objects that are deleted. Thus, a situation is created where conflicts (e.g., two differing versions of the same object) are created and data integrity quickly breaks down. Typically, deleting one data element that is referenced by another data element creates what is called a dangling reference. Furthermore, it is possible that a dangling reference may be propagated throughout the system through synchronization processes not attuned to this problem.

What is therefore needed is a method for databases to efficiently store information in their databases so that the data can be accessible to users in as efficient a manner as possible on all platforms that the database may be accessed on. Additionally, to deal with the complex environment and cross-references between items, a method to fix the problem of dangling references is needed.

### SUMMARY OF THE INVENTION

In accordance with various embodiments of the present invention, a method and system for maintaining data integrity across a plurality of devices using reference identifications is provided. Reference IDs are maintained when a conflict arises and the primary version (the data object which holds the reference ID) is to be superseded by a new version.

In accordance various embodiments of the present invention, a method and system for maintaining data integrity across a plurality of devices using a global synchronization clock per synchronization node is provided.

In accordance with various embodiments of the present invention, a method and system for maintaining data integrity across a plurality of devices using snapshots during synchronization is provided.

In accordance with various embodiments of the present invention, a method and system for maintaining data integrity across a plurality of devices using forwarding deletes is provided.

In accordance various embodiments of the present invention, a method and system for maintaining data integrity across multiple device using update ordering is provided. The above exemplary embodiments are not meant to restrict the scope of this application. Though not enumerated in the above embodiments the programs attempting to access data need not be running locally, but rather may be running on networked device connected by some means either wired or wireless.

Additional features and advantages of the invention will be set forth in the description which follows, and in part will be obvious from the description, or may be learned by practice of the invention.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram of an exemplary system of networked computing devices.

FIG. 2 is a block diagram of an exemplary computing device.

FIG. 3 is a flow diagram of an exemplary method of maintaining a reference ID.

FIG. 4 is a flow diagram of an exemplary method of using a global clock to synchronize multiple data stores.

FIG. 5 is a flow diagram of an exemplary method of a snapshot being used to retain object versions to eliminate dangling references.

FIG. 6 shows an exemplary method of using forwarding deletes to reduce dangling references.

FIG. 7 shows an exemplary method of update ordering to prevent dangling references.

### DETAILED DESCRIPTION

Various embodiments of the invention are described in detail below. While specific implementations involving electronic mobile devices (e.g., portable computers) are described, it should be understood that the description here is merely illustrative and not intended to limit the scope of the various aspects of the invention. A person skilled in the relevant art will recognize that other components and configurations may be easily used or substituted than those that are described here without parting from the spirit and scope of the invention.

A data object, such as a file or record, typically has two properties of interest, an identity (or identifier) and content. The identity property allows two data objects to be compared to determine whether they represent the same data. Data objects having the same identity may then be compared for content. Thus, for example the same data object O may be stored in a portable computing device (P) and on a desktop computer (D). If data object O is modified on the portable computing device (P) but not on the desktop computer (D), then a situation exists where data objects having the same identity have different content on the respective devices. When a data object is modified in a node, a presumption of priority is made where the modified data object takes precedence over the previous version of the object and that accordingly, descendant data takes precedence over ancestor data.

By including ‘pedigree’ information that preserves edit priority, conflicts in which data objects having the same identity but different content can be resolved. The pedigree may be viewed as a change history of a data item and may include a node identifier indicating the device at which the data item is stored, and a counter such as a sync counter (which increments after each synchronization event). For example, a record created at a desktop computer with node identifier “D” and current sync clock counter at 21 is said to have pedigree D21. During a synchronization event, another computing device such as the portable computing device may receive a copy of the data item. If the data item is then subsequently modified on the portable computing device, the pedigree of the data item stored on the portable computing device is updated to include a new node identifier and counter. For example, the pedigree D21 may become D21P43 where P identifies the portable computing device and 43 is the value of the portable's sync counter at the time of the modification. Another way that the pedigree may be modified is, for example, if the data object is modified after a synchronization event. The sync counter is incremented to 22 for the desktop, and the pedigree is D22. Then, if the object were to be modified again before the next synchronization, the pedigree would not change because the clock has not been ticked. Of course, other schemes of identification can be used in accordance with the present invention. An additional important property of objects that exist in a data store or data stores is that inter object referencing may exist. For example, an object named ‘Honda’; may also share the ‘Cars’ category with other objects within multiple data stores. As such, this object may be related to other objects. Moreover, there may not be a restriction on references, as any object may reference another, which creates interconnections within data stores and throughout multiple data stores. These data stores may not be on separate devices as there may be multiple data stores on an individual device. Furthermore, multiple data stores may also contain the same information gained through synchronization.

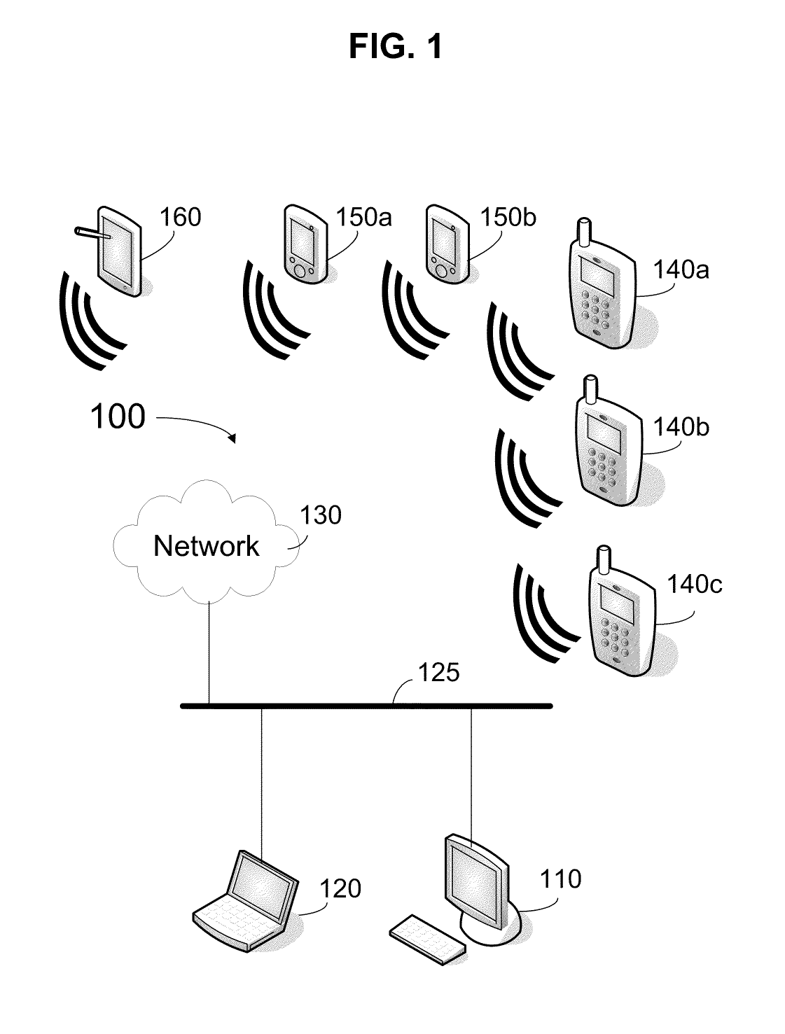

As noted above, a plurality of devices in a networked system may be synchronized so that each node of the system obtains the most up-to-date version of a set of data. FIG. 1 shows an exemplary system 100 of networked computing devices. This system 100 will be used in describing the methods of the present invention below. However, this system is merely exemplary in that the present invention is applicable to any device having data storage capability and to any plurality of such devices requiring synchronization.

A “pedigree” is generally a record of change(s) of a database object, and may be used to indicate if an object has changed since a synchronization session. Commonly owned U.S. patent application Ser. No. 10/159,461, issued as U.S. Pat. No. 7,337,193, filed May 31, 2002, discloses a novel pedigree system that is well suited to embodiments of the present invention, and is hereby incorporated herein by reference in its entirety. It is to be appreciated that embodiments of the present invention are well suited to pedigrees and methods of creating and updating pedigrees other than those described herein and in the aforementioned patent application.

Referring again to FIG. 1, the system 100 includes a desktop computer 110 and a laptop computer 120 coupled to a data communication bus 125. The data communication bus 125 may comprise, for example, a serial communication bus, a parallel bus, an Ethernet LAN link, Wireless connection, and the like. The bus 125 may provide communication with one or more servers on a network 130, for example, a Wide Area Network, Local Area Network or any collection of systems interconnected using a number of well known network protocols to dictate the communications traffic. A larger heterogeneous network may contain a wide variety of computer devices. For example, three such types of portable computer devices depicted in FIG. 1 are cellular telephones 140a-c, personal digital assistants (PDA) 150a-b and a tablet PC 160. Cellular telephones are beginning to merge with PDA's, an example of such convergence would be a Palm™ Treo™ and although depicted separately, the present invention is intended to include converged devices that share the same or similar characteristics. Cellular telephones' complexity is ever increasing, including their organization needs, and as such require access to data as well as being available for other systems to access its data. In general, cellular telephones use a wireless protocol for making data connections, for example, Bluetooth, Wi-Fi, a Cellular Network or a cable and dock configuration, which electrically and mechanically tethers the device to another computer. For purposes of this example, PDAs 150a-b are devices that have all of the communications requirements of modern cellular telephones. Similarly, a tablet PC 160 is depicted in FIG. 1 having the capability to wirelessly communicate with network 130. Tablets are taking the place of PDA's in some sectors especially in the medical field where they are often used as part of paperless chart systems for doctors and hospitals.

The laptop computer 110, the desktop computer 120, the cellular phone 140a-c, PDA 150a-b and the Tablet PC 160 all can include one or more processors for running an operating system and executing program applications or coprocessors designed to offload specific tasks from the CPU. The devices 110, 120, 140a-c, 150a-b and 160 can include local or attached memory, including, for example, volatile (RAM) and non-volatile (ROM) memory for storing data. In preferred embodiments, the computing devices 110, 120, 140a-c, 150a-b and 160 of the system 100 all operate on a Linux-based platform such as the Access Linux Platform (ALP), but the present invention is also applicable in systems in which other operating systems are adapted for mobile/portable devices and information appliances such as Symbian, Windows Mobile, Blackberry OS, and the like.

Each of the computing devices 110, 120, 140a-c, 150a-b and 160 may execute personal information management (PIM) applications including calendar, address book and email applications. Information input by a user of such applications is initially stored locally in data stores located on each of the devices 110, 120, 140a-c, 150a-b and 160. As discussed further below, the data stores on the devices may be duplicative to the extent that the same data objects are stored in each node (device). For example, appointment information on a personal calendar may be stored on each of the devices for easy access regardless of which device the user is currently operating.

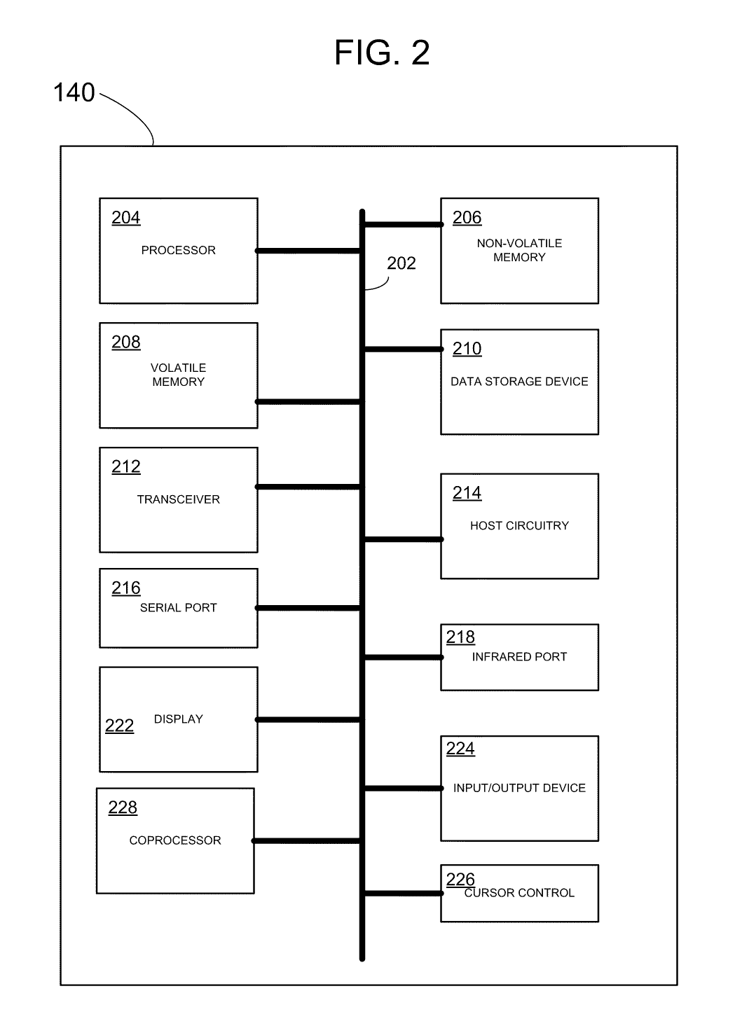

FIG. 2 is a block diagram showing functional components of an exemplary computing device 140, such as 110, 120, 140a-c, 150a-b and 160 in which embodiments of the present invention may be implemented. In one embodiment, the computing device 140 may include an address/data bus 202 to which the functional components of the device 140 are coupled for inter-communication. The functional components include a central processor 204 adapted to run an operating system and to execute tasks and applications over the operating system platform. The central processor can consist of multiple processors or cores and may be part of a distributed network of processors. The central processor 204 may utilize memory resources of a non-volatile memory 206 (for example, ROM, programmable ROM (PROM), erasable and electrically-erasable programmable ROM (EPROM, EEPROM) or flash ROM), EPROM, EEPROM) and a volatile memory 208 (for example, SRAM, DRAM) in its operations. The volatile memory 208 may store organized structures of records such as data stores discussed above and in further detail below. The computing device 140 may further include an optional data storage device 210 such as a secure digital card or media card which may be removable.

The computing device 140 may be equipped with or coupled to a transceiver 212 enabling a wireless communication link to a wireless base station (not shown). In some embodiments, the computing device 140 may communicate with other devices in the networked system via a base station and gateway (not shown). The transceiver 212 is coupled to host circuitry 214 which may comprise or include a digital signal processor (DSP) for processing received/transmitted data. The host circuitry may also include an asynchronous receiver-transmitter (UART) module that provides serial communication capability via a serial port 216 and IR (infrared) port 218. Alternatively, the processor 202 may perform some or all of the functions performed by the host circuitry 214.

The computing device 140 may also be equipped with a coprocessor 228. A coprocessor would be used to handle advanced application specific tasks that would otherwise take valuable system resources. The coprocessor 228 may also be a DSP used, for example, for audio processing in voice recognition or text to speech systems or a Field Programmable Gate Array (FPGA) that could be programmed to perform application specific tasks.

The computing device 140 might also be equipped with input/output devices including a display device 222 such as a screen or a haptic display, an alphanumeric input/output device 224, and an optional on-screen cursor control 226 for communicating user input and command selection to the processor 204. The input/output device 224 may also be a GPS device or any device that may require some input/output of data connecting to the system following known protocols. In various embodiments, the computing device 140 may include other elements not shown in FIG. 2.

In accordance with various embodiments of the present invention, a method for maintaining data integrity across a plurality devices is provided. For example, a data store or collection of data stores may utilize reference IDs. A reference ID is an identification that is maintained for the life of an object and identifies the “proper” object to use. Upon synchronization or any other similar process, conflicts may arise between objects that should be the same, but for a variety of reasons, now contain differing content. Because during a resolution process, one or more of the objects to be resolved is to be deleted, it is necessary to maintain a reference ID and “assign” it to the proper object after resolution.

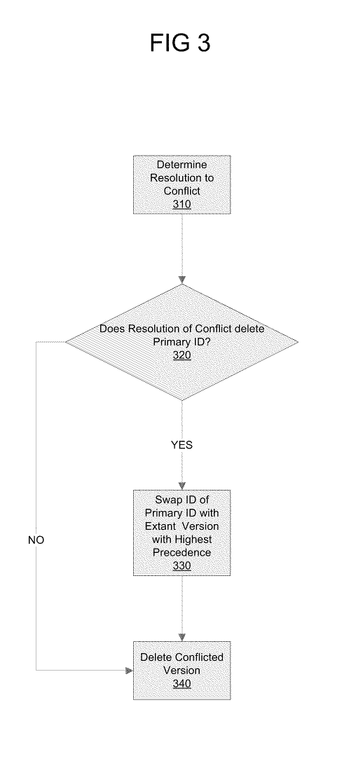

In accordance with various embodiments of the present invention, each object is provided with a locally unique ID and a globally unique ID. A local ID is a small integer value that is meant to only be used on a local system where the number of entries is generally kept smaller than on a global scale, in contrast a Global ID is a large integer value. The smaller length in size of a Local ID compared with a Global ID enables for increased of ease of use and increased space efficiency as well as shortened processing and search times. The Global ID is the same across all nodes and the local unique ID may vary for different data nodes. All objects define a referenced version that constitutes a valid reference for as long as the object exists. FIG. 3 is a flow diagram of an exemplary method of maintaining a reference ID when a conflict arises. Reference IDs are maintained when a conflict arises and the primary version (the data object which holds the reference ID) is to be superseded by a new version. A conflict may arise in any number of ways. For example, a conflict may arise where an object resides on a handheld and on a desktop. They both may have the same pedigree of H1, where the object is modified on the handheld so that one data item is modified, for example, a phone number, giving the object pedigree H2. Before synchronization, the same object is modified on the desktop, but with a different phone number. The object's pedigree is H1D2. When the handheld and desktop subsequently synchronize, a conflict will arise because two different phone numbers for the same object have the same precedence.

Referring to FIG. 3, the process of maintaining a reference ID for an object held in a data store is performed. In step 310, after a conflict is recognized, the system, assuming the user is not resolving the conflict, determines the resolution to the conflict. This is generally a matter of finding which version has the highest precedence. Next, a determination is made as to whether the conflict resolution deletes the primary ID, which is the reference ID, step 320. This step is required because it determines whether the reference ID would be extant (i.e., still in existence) after the conflict resolution. If the conflict resolution does not delete the primary ID, the process resolves the conflict by deleting the conflicted version, step 340. However, if the primary ID must be deleted, then the process swaps the IDs of the primary ID with the ID of an extant version, step 330, which then becomes the primary ID as well as the reference ID. Then, the process resolves the conflict by deleting the conflicted version, step 340.

During a synchronization operation, individual data stores may use individual sync clocks. However, this can cause problems if the clocks do not tick in a synchronized fashion, which may skew synchronization results. For example, one possible implementation that exists in some systems is for each data store to have its own sync clock. However, a problem arises where if one clock does not tick at the same time as the clocks in the rest of the devices, dangling references are created. For example, consider a situation where if a new object O1 in data store D1 references a new object O2 in data store D2, and both objects O1 and O2 are added relatively simultaneously. Also consider that object O1 is added before D1's clock ticks, and object O2 is added just after D2's clock ticks. During a synchronization, object O1 will be added whereas object O2 will not be added. This situation creates a dangling reference from object O1 to object O2 when O1 is synchronized with another node.

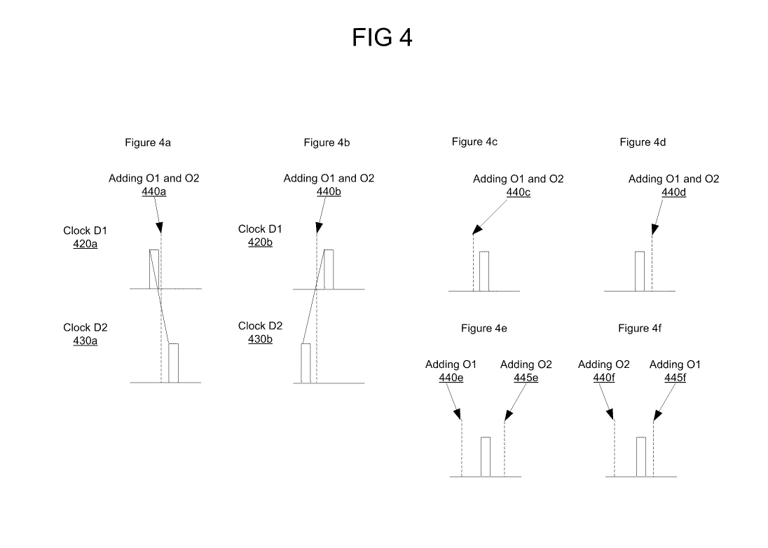

In accordance with various embodiments of the present invention, synchronized global clocks are used to maintain data integrity. FIG. 4 illustrates an exemplary embodiment of the present invention whereby a synchronized global clock tick per synchronization node for synchronizing data stores is provided. A synchronization node is defined as a set of sync-able data stores. FIG. 4a shows the use of two local Clocks D1 (420a) and D2 (430a) for their respective nodes, D1 and D2. At time 440a, an object (O1) is added to a node (D1) and an object (O2) is added to another node (D2). Additionally, O1 is referenced by O2. In this example, O1 is added after the Clock D1 is ticked and O2 is added before Clock D2 is ticked. Thus, upon performing a synchronization, O1 is not included in the synchronization while O2 is. This creates a dangling reference from O2 to O1. FIG. 4b shows the reverse of this situation where O1 is added to D1 before Clock D1 ticks and O2 is added after Clock D2 ticks. Unlike in FIG. 4a, this does not create a dangling reference as O1, which is involved in the synchronization does not reference O2, which was not synchronized. FIGS. 4c through 4f depict an exemplary embodiment that uses a global synchronized clock. FIG. 4c shows O1 and O2 being added to their respective datastores, D1 and D2 before the global clock tick. Upon synchronization, this does not create a conflict because both O1 and O2 are involved in the synchronization. FIG. 4d shows O1 and O2 being added to their respective data stores, after the clock ticks. This does not create a conflict as neither object is involved in the synchronization. FIG. 4e shows O1 being added to D1 before the clock tick and O2 being added to D2 after the clock tick. This also does not create a conflict as this situation is equivalent to the situation in FIG. 4b. FIG. 4f reveals a conflict created as it shows O1 being added to D1 after the clock tick and O2 being added to D2 before the clock tick. This creates a conflict similar to the one created in FIG. 4a.

In accordance with various embodiments of the present invention, a method for using snapshots during synchronization is provided. A snapshot is a pair of pedigrees that define the upper and lower bounds for the priority of objects to be included in a synchronization session.

Unfortunately, it is possible for a modification that occurs after the snapshot is taken to result in the transmission of a dangling reference. For example, consider a situation where a new object O1 in data store D1 references a new object O2 in data store D2. Furthermore, consider that both new objects are initially included in the session snapshot. By definition, if a concurrent process modifies object O2 before it is read from data store D2, then object O2's priority will fall outside the snapshot. Therefore, when object O1 is read from data store D1, it will contain a dangling reference to object O2.

In accordance with various embodiments of the present invention, this problem is avoided by retaining all object versions included in any “open” snapshot. For example, when a change is made to an object included in an open snapshot, a more recent version of the object is created while retaining the existing version. When the snapshot is closed, any “old” object versions are deleted, unless required for another open snapshot. So, transmission of dangling references is avoided. Unnecessary object versions are purged when a snapshot is closed.

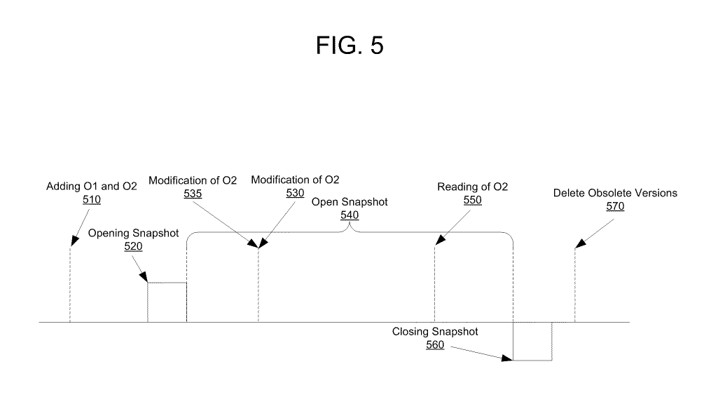

In an exemplary embodiment, FIG. 5 shows a method whereby object versions are retained within a change snapshot. For example, two objects O2 and O1 are added to data store 2 and 1 respectively (step 510). Additionally, object O1 references object O2. A snapshot is then opened for a synchronization session between two nodes D1 and D2 (step 520). When the snapshot is opened, both objects O1 and O2 are included in the snapshot, which is now considered open (540). If while the snapshot is open, step 530 occurs (e.g., where a modification of object O1 takes place before object O1 is read from the data store at step 550), then object O1 would be out of the scope of the snapshot and would not be synchronized creating a dangling reference. However, the method retains the previous version of object O1, which is included in the snapshot preventing the creation of a dangling reference. This creates an obsolete version for object O1. After closing the snapshot, at step 560, all obsolete versions are deleted unless the object is still in another open snapshot, step 570. The resolution of the conflict may include the exemplary method or other similar methods described in FIG. 3 where a reference ID is maintained. As another example, O1 may be modified to reference an object O3 (step 535) instead of 02 before O1 is read (step 555). If the version of O1 modified in step 535 read in step 555 is transmitted, a dangling reference to O3 is created when O3 is not present on D2. As such, the version prior to modification at 535 is read and transmitted to node D1 to prevent the dangling reference.

Another situation that threatens data integrity is when a data store enforces data constraints. In implementing data constraints, it is possible that the data store may choose to delete new objects that violate those constraints. This deletion will cause any references to the deleted object to “dangle.” For example, consider a situation where there are two categories in two different data stores named “Business” and “Business2”. Then a user renames “Business2” to “Business” in one of the data stores, and synchronizes the two data stores. If we assume in this example that category names are unique, then the other data store must delete one of the categories named “Business.” Unfortunately, this means references to the deleted category will “dangle.” The data store may issue a delete that forwards references from the deleted version of “Business.” This forwarding allows the members of the deleted category to seamlessly become members of the non-deleted category and thus avoids the creation of dangling references.

To avoid this problem or similar problems, in accordance with various embodiments of the present invention, a method and system for maintaining data integrity across a plurality of devices through the use of forwarding deletes is provided. A forwarding delete is whereby, through the resolution of a conflict, a conflicted version of an object is deleted and all references are then forwarded to an extant version of the object. Forwarding deletes may also be used in situations where two similar but different objects exist where one object will replace the other and the references to both objects are to now reference just one. The forwarding process is one where the system maintains knowledge of deleted objects in relation to an extant version of the object and its local ID, thus enabling the system to when receiving a request for a none extant object, to automatically send the extant version.

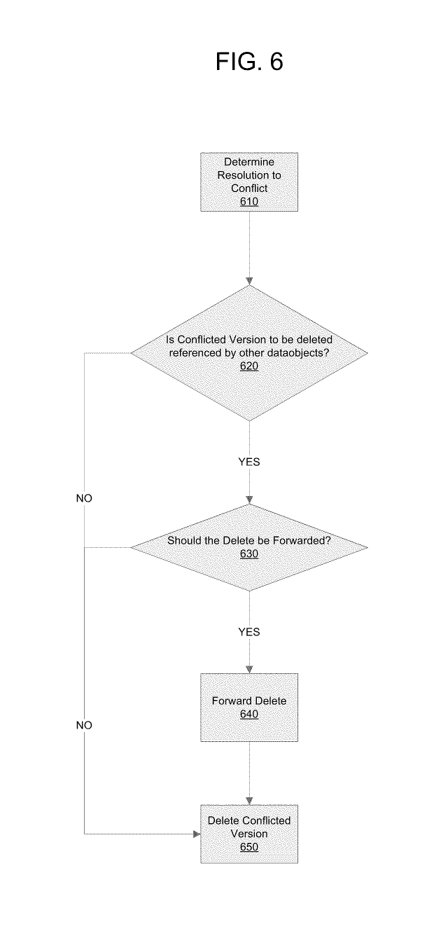

FIG. 6 is a flowchart of an exemplary embodiment of a method for forwarding deletes. This method may be similar to the method involved in FIG. 3 for maintaining a reference ID. Also, this method may be implemented in step 560 of FIG. 5. The method includes determining a resolution to the conflict (step 610), so that one non conflicted version of an object exists. Next, it is determined whether other objects reference the non-conflicted version of the object, step 620. If not, the object can simply be deleted, step 650. If other objects do reference the non-conflicted version, it is determined whether the delete should be forwarded (e.g., based on user input or program determination), step 630. If the forwarding deletes are not desired, then the conflicted version is deleted (step 650). If forwarding deletes are desired, then all references to the conflicted version to be deleted are forwarded to an extant version of the object (step 640). Then, the conflicted version is deleted (step 650). The actual method of the delete being forwarded to referencing objects is carried out through mechanism, where a node retains knowledge of deleted objects and their extant version, so that when an object requests the referenceable id of a non-extant version of an object, the node provides the id to the extant version of the object.

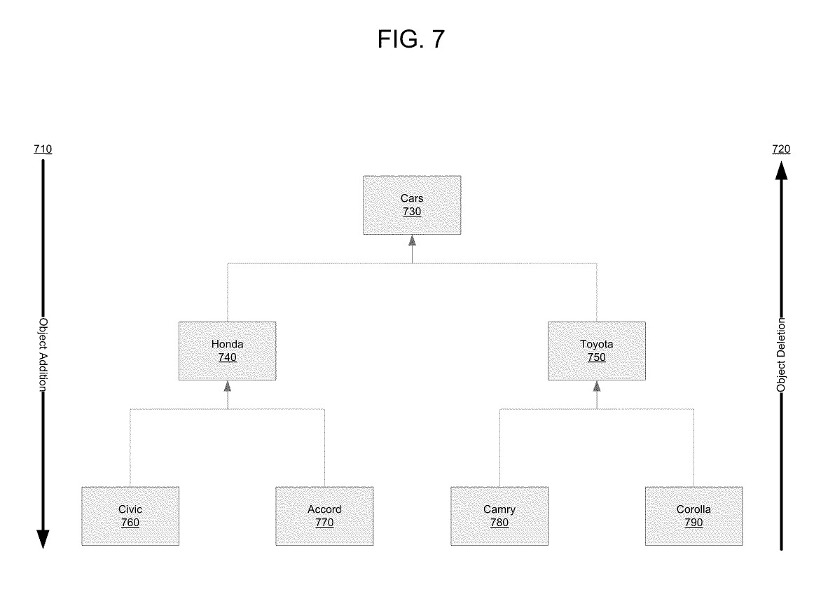

In accordance with various embodiments of the present invention, maintaining data integrity across multiple devices may utilize update ordering. The order in which object references are added or deleted amongst related data objects is called update ordering. In some embodiments, the nature of the relationship determines the order in which objects are added or deleted. In other embodiments, enabling data stores to indicate that a particular data store is referenced facilitates update ordering. FIG. 7 shows an exemplary method of update ordering. For example, to prevent a permanent dangling reference due to a referencing object being added to a data store and the synchronization being interrupted before the referenced object is synchronized update ordering may be used. In accordance with some embodiments of the present invention, when objects are added, referenced objects are added first. When objects are deleted, referencing objects are deleted first.

Object 730 is an object named cars and is meant as a category. Objects 740 and 750 are subcategories of cars, in this case two brands, Toyota and Honda. Objects 760 through 790 are models of cars. As can be seen 760 through 790 reference the brand of car that they belong to and objects 740 and 750 reference 730 showing that they are cars. Arrow 710 shows how the addition process follows in this case a top down process, where objects that are referenced are added first. This prevents dangling references from existing because an object with a reference to another object is not added before the referenced object. In the situation shown FIG. 7, object 730 would be added first followed by object 740 and object 750 and finally objects 760 through 790. Object 720 shows how the addition process follows in this case a bottom up process, where objects that reference another object are deleted first. This prevents dangling references from existing because references are removed before what they are referencing. In the situation shown FIG. 7, objects 760 through objects 790 would be deleted first followed by objects 740 and 750 and finally object 730. It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention.

Further, although the invention has been described herein with reference to particular structure, materials and/or embodiments, the invention is not intended to be limited to the particulars disclosed herein. In particular, while the invention has been described with reference to portable devices such as personal digital assistants, mobile phones, smart phones, camera phones, pocket personal computers and the like, the invention applies equally to other devices able to execute software instructions and containing data stores, devices having embedded systems (referred to as ‘information appliances’) including, for example, small televisions, media players, set top boxes, automotive navigation devices, GPS devices and portable gaming devices (e.g., Sony Play Station®), personal computers, servers or any computational device that can execute software. In addition, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method for maintaining data integrity in a plurality of data stores amongst a network of computing devices during a synchronization process, comprising the steps of:
providing a first data object having a primary identification and a reference identification;
determining whether a conflict exists between the first data object and a second data object having an identification;
resolving the conflict;
if the resolving the conflict deletes the first data object having the primary identification, then swapping the primary identification of the first data object with the identification of the second data object; and
deleting the first data object.

2. The method according to claim 1, wherein the identifications of the first and second data objects comprise globally unique identifiers and pedigrees.

3. The method according to claim 2, further comprising a synchronization node having a global synchronization clock, wherein the synchronization node comprises a set of the plurality of data stores.

4. The method of claim 1, further comprising the steps of:
opening a snapshot within a node;
determining whether a modification of the first data object has occurred, wherein if a modification has occurred, creating an obsolete version of the first data object;
deleting the obsolete version of the first data object after the resolving the conflict.

5. The method according to claim 1, further comprising the steps of:
determining whether other data objects each having a reference refer to the first deleted data object;
determining whether at least one of the other data object references should be deleted;
designating the at least one of the other data object references to refer to the second data object.

6. A method for maintaining data integrity in a plurality of data stores amongst a network of computing devices during a synchronization process, comprising the steps of:
providing a plurality of data stores having referenced objects and referencing objects;
initiating a synchronization involving at least two of the pluralities of data stores;
adding objects present in one of the data stores that are not present in the other data stores that are to be synchronized and are designated to be added by adding the referenced objects to the other data stores before adding the referencing objects;
deleting objects from one of the data stores that are to be synchronized that are present in that data store and are designated to be deleted by deleting the referencing objects before the referenced objects.

7. The method according to claim 6, wherein the referenced objects and the referencing objects are associated with pedigrees.

8. The method according to claim 6, further comprising a synchronization node having a global synchronization clock, wherein the synchronization node comprises a set of the plurality of data stores.

9. A system of computing devices comprising:
a network connecting a plurality of computing devices, each device having a data store for storing one or more data objects, each data object having a reference identification;
each device having a processor adapted to establish communication with the network and execute an application process, the application process adapted to:
initiate a synchronization process between at least two data stores, the data stores having at least one data object with a primary identification;
determine conflicts between the data stores by examining the data objects;
resolve conflicts between the data stores by adding, modifying, or deleting at least one of the data objects;
swap the primary identification of a first data object with the identification of a second data object and designate the second data object as a second primary identification, if resolving the conflict between the data stores deletes the first data object having the primary identification; and
delete the first data object.

10. The system of claim 9, wherein the identifications are associated with pedigrees.

11. The system of claim 9, wherein the application process is further adapted to maintain a global synchronization clock for each synchronization node, wherein a synchronization node comprises a plurality of stores.

12. The system of claim 9, wherein the application process is further adapted to:
open a snapshot between within a node;
determine whether a modification of a first data object has occurred, wherein if a modification has occurred, creating an obsolete version of the first data object;
deleting the obsolete version of the first data object after the resolving the conflict.

13. The system of claim 9, wherein the application process is further adapted to:
determine whether other data objects have a reference referring to the first data object;
track the deletion of the object and the associated ID;
forwarding said associated ID with the ID of the extant object.

14. The system of claim 9, wherein the application process is further adapted to:
identify referenced and referencing data objects;
add objects designated to be added by adding the referenced objects to the other data stores before adding the referencing objects;
delete objects designated to be deleted by deleting the referencing objects before the referenced objects.
